(19) United States
(12) Patent Application Publication
(10) Pub. No.: US 2006/0152171 A1
(43) Pub. Date: Jul. 13, 2006

(54) Liquid crystal display method and liquid crystal display device

(76) Inventor: Hiroshi Kinjou, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/312,186

(22) Filed: Dec. 20, 2005

(30) Foreign Application Priority Data
Jan. 12, 2005 (JP) 2005-004879

(51) Int. Cl. H05B 41/16

(52) U.S. Cl. 315/274

(57) ABSTRACT

There is provided a liquid crystal display device using cold cathode fluorescent tubes as light sources for a liquid crystal display panel, wherein a plurality of the cold cathode fluorescent tubes, preferably two units of the cold cathode fluorescent tubes are adopted, so that lighting time of one unit of the cold cathode fluorescent tube is first reduced, and lighting time of another unit of the cold cathode fluorescent tube is subsequently reduced to thereby enable a luminance range from the maximum luminance to the minimum luminance to be widened. Further, there is provided a liquid crystal display device wherein luminance adjustment is implemented by keeping luminance characteristics of cold cathode fluorescent tubes in the best state by measuring temperature of the cold cathode fluorescent tubes or controlling the temperature of the cold cathode fluorescent tubes at a constant temperature to thereby enable luminance adjustment in a wide range to be implemented without causing one-sided lighting. More specifically, there is provided a liquid crystal display device comprising cold cathode fluorescent tubes for irradiating a liquid crystal display panel with light, self-excited push-pull circuits for lighting up the cold cathode fluorescent tubes, respectively, gate bias voltage supply circuits for generating a signal for applying a high AC voltage to the cold cathode fluorescent tubes against the self-excited push-pull circuits, respectively, and PMW control means for providing the gate bias voltage supply circuits with ON-duty signals, respectively, wherein the cold cathode fluorescent tubes include a plurality of the cold cathode fluorescent tubes, and the plurality of the cold cathode fluorescent tubes each are provided with the self-excited push-pull circuit, the gate bias voltage supply circuit, and the PMW control means, a dimming controller being provided for supplying signals to cause the cold cathode fluorescent tubes to discharge, respectively, against the respective PMW control means.

### FIELD OF THE INVENTION

The invention relates to a liquid crystal display method, and a liquid crystal display device, and more particularly, to a liquid crystal display device using backlights, enabling adjustment in a wide range by improving a backlight part during liquid crystal display.

### BACKGROUND OF THE INVENTION

With a liquid crystal display device according to a first example of the conventional technology, an edge light method is adopted in backlighting, and as shown in FIG. 6, the liquid crystal display device comprises a backlight unit 13 comprised of a cold cathode fluorescent tube 11, and a cold cathode fluorescent tube lighting device 12, a liquid crystal display panel 14 using the backlight unit 13 as a light source thereof, and a PWM control circuit 15 for executing operation control of the cold cathode fluorescent tube lighting device 12.

As shown in FIG. 7, the liquid crystal display panel 14 comprises the cold cathode fluorescent tube 11 serving as a backlight, a light-guide plate 17 on which light emitted from the cold cathode fluorescent tube 11 falls from one side, a reflector 16 for causing the light from the cold cathode fluorescent tube 11 to be reflected toward the light-guide plate 17, reflecting sheets 18, 19, disposed at a position underneath the light-guide plate 17, and at a position opposite from the cold cathode fluorescent tube 11, in a direction in which the falling light is guided, respectively, for causing the light propagating along the light-guide plate 17 to be reflected upward, a diffusion sheet 20 provided at a position above the light-guide plate 17, for causing the light from the light-guide plate 17 to be diffused, and a liquid crystal face 21 disposed over the diffusion sheet 20.

With the light from the backlight of a configuration described as above, the light emitted from the cold cathode fluorescent tube 11 is first condensed by the reflector 16 to be then caused to fall on the light-guide plate 17. The light falling on the light-guide plate 17 is reflected upward in the figure by the reflecting sheets 18, 19, respectively. The light as reflected is turned into homogeneous light by the diffusion sheet 20 before falling on the liquid crystal face 21.

The PWM control circuit 15 is capable of adjusting luminance of the cold cathode fluorescent tube 11 by means of a dimming method for effecting ON-duty control by pulse width modulation, and generates a control pulse signal Scnt for luminance adjustment before outputting the same to the cold cathode fluorescent tube lighting device 12.

The cold cathode fluorescent tube lighting device 12 is connected to the cold cathode fluorescent tube 11, and when the control pulse signal Scnt for ON-duty, at the low level, is received from the PWM control circuit 15, a DC voltage VA supplied from a DC power source E undergoes voltage division by resistors R1, RV1, and a divided voltage then biases respective gate voltages of FETs (Q2, Q3) via an intermediate tap CT of a feedback winding NB of a transformer T1, whereupon a self-excited push-pull circuit 22 actuates oscillation, and converts the divided voltage into a high AC voltage, the high AC voltage as converted being supplied to the cold cathode fluorescent tube 11, to thereby light up the cold cathode fluorescent tube controller 11.

More specifically, the cold cathode fluorescent tube lighting device 12 comprises the DC power source E for generating the DC voltage at a voltage VA, a gate bias voltage supply circuit 23, and the self-excited push-pull circuit 22 including the transformer T1, an inductor L1, capacitors C1, C2, and a pair of the n-channel FETs (switching elements) Q2, Q3.

The transformer T1 as a constituent of the self-excited push-pull circuit 22 is provided with a primary winding N1 having the intermediate tap CT, a secondary winding N2, and the feedback winding NB, and the secondary winding N2 has one end grounded, and the other end coupled to one end of the capacitor C2. The capacitor C2 has the other end coupled to the cold cathode fluorescent tube 11. The inductor L1 is an element for causing the DC power source E to function as a constant current source, interconnecting the DC power source E and the intermediate tap CT of the primary winding N1 of the transformer T1. Respective drains of the switching elements Q2, Q3 are connected to respective ends of the primary winding N1, and respective gates thereof are connected to respective ends of the feedback winding NB.

With such a circuit configuration as described, an oscillation frequency of the self-excited push-pull circuit 22 is dependent primarily on the capacitor C1 coupled in parallel to the primary winding N1 of the transformer T1, and inductance of the primary winding N1 of the transformer T1.

The gate bias voltage supply circuit 23 has the function of supplying a gate bias voltage to the respective switching elements Q2, Q3 of the self-excited push-pull circuit 22 via the feedback winding NB, and adjusting luminance of the cold cathode fluorescent tube 11 in accordance with the control pulse signal Scnt as inputted, and a switching element Q1 connected to the PWM control circuit 15 via a resistor R2 and an output end of the gate bias voltage supply circuit 23 are connected to a node where the DC voltage undergoes voltage division by the resistor R1, and the variable resistor RV1, further the output end being connected to the intermediate tap CT of the feedback winding NB of the transformer T1.

Now, operation of the cold cathode fluorescent tube lighting device 12 of such a configuration described as above is described hereinafter. First, when the control pulse signal Scnt is controlled at the low level, the switching element Q1 is shifted to the OFF state. Then, the divided voltage is generated through voltage division by the resistor R1, and the variable resistor RV1, and the divided voltage is applied to the respective gates of the switching elements Q2, Q3 as a bias voltage via the intermediate tap CT of the feedback winding NB, thereby turning ON either of the switching elements Q2, Q3. When either the switching element Q2, or the switching element Q3 is turned ON, oscillation is started by the agency of the inductance of the primary winding N1 of the transformer T1 and the capacitor C1.

In a state where the self-excited push-pull circuit 22 is once actuated, the self-excited push-pull circuit 22 continues self-excited oscillation by the agency of the bias voltage supplied to the respective gates of the switching elements Q2, Q3 via the feedback winding NB on the basis of the OFF state of the switching element Q1, and a voltage undergoing positive feedback to the respective gates of the switching elements Q2, Q3 via the feedback winding NB. As a result, the high AC voltage is induced in the secondary winding N2. Accordingly, the cold cathode fluorescent tube 11 receives the high AC voltage as induced, and can be lit up.

Thus, luminance adjustment of the cold cathode fluorescent tube 11 is implemented by turning ON/OFF oscillation operation of the self-excited push-pull circuit 22 according to an ON/OFF duty ratio of the switching element Q1 by PWM control.

Next, there is described a liquid crystal display device according to a second example of the conventional technology with reference to the accompanying drawings.

With the liquid crystal display device according to the second example, control of a high AC voltage supplied to a cold cathode fluorescent tube serving as a backlight is effected by controlling a control pulse signal Scnt outputted from a PWM control device by use of the so-called dimmer for luminance adjustment, and as shown in FIG. 8, the liquid crystal display device comprises a backlight unit 13 comprised of a cold cathode fluorescent tube 11, and a cold cathode fluorescent tube lighting device 12, a liquid crystal display panel 14 using the cold cathode fluorescent tube 11 of the backlight unit 13, serving as a light source, a PWM control device 15X for executing operation control of the cold cathode fluorescent tube lighting device 12, and a dimmer 24 for luminance adjustment to control a control pulse signal Scnt sent out from a PWM control device 15X.

The liquid crystal display panel 14 is the same in configuration as that described with reference to the first example, as shown in FIG. 7, omitting therefore description thereof.

The PWM control device 15X is capable of adjusting luminance of the cold cathode fluorescent tube 11 by means of the dimming method for effecting ON-duty control by pulse width modulation, and generates the control pulse signal Scnt for luminance adjustment before outputting the same to the cold cathode fluorescent tube lighting device 12.

The dimmer 24 for luminance adjustment is to control ON-time for luminance adjustment, controlling an ON-time width of the control pulse signal Scnt outputted from the PWM control device 15X. The ON-time width corresponds to a dimmer value at a ratio of 1:1.

The cold cathode fluorescent tube lighting device 12 is connected to the cold cathode fluorescent tube 11, and divides a DC voltage VA supplied from a DC power source E when the control pulse signal Scnt at the low level is received from the PWM control circuit 15X, thereby applying a bias voltage to switching elements Q2, Q3, respectively, whereupon oscillation is started to cause a high AC voltage to be generated on the side of a secondary winding N2 according to a winding ratio of a transformer T1, and the high AC voltage as converted is supplied to the cold cathode fluorescent tube 11, to thereby light up the cold cathode fluorescent tube controller 11.

More specifically, the cold cathode fluorescent tube lighting device 12 comprises the DC power source E for generating the DC voltage at a voltage VA, a gate bias voltage supply circuit 23, and a self-excited push-pull circuit 22 including the transformer T1, an inductor L1, capacitors C1, C2, and a pair of the n-channel FETs (switching elements) Q2, Q3.

The transformer T1 as a constituent of the self-excited push-pull circuit 22 is provided with a primary winding N1 having an intermediate tap CT, the secondary winding N2, and a feedback winding NB, and the secondary winding N2 has one end grounded, and the other end coupled to one end of the capacitor C2. The capacitor C2 has the other end coupled to the cold cathode fluorescent tube 11. The inductor L1 is an element for causing the DC power source E to function as a constant current source, interconnecting the DC power source E and the intermediate tap CT of the primary winding N1 of the transformer T1. Respective drains of the switching elements Q2, Q3 are connected to respective ends of the primary winding N1, and the respective gates thereof are connected to respective ends of the feedback winding NB.

With such a circuit configuration as described, an oscillation frequency of the self-excited push-pull circuit 22 is dependent primarily on the capacitor C1 coupled in parallel to the primary winding N1 of the transformer T1, and inductance of the primary winding N1 of the transformer T1.

The gate bias voltage supply circuit 23 has the function of supplying a gate bias voltage to the switching elements Q2, Q3, respectively, and adjusting luminance of the cold cathode fluorescent tube 11 in accordance with the control pulse signal Scnt as inputted, and a switching element Q1 connected to the PWM control device 15X via a resistor R2 and an output end of the gate bias voltage supply circuit 23 are connected to a node where the DC voltage is divided by the resistor R1, and the variable resistor RV1, further the output end being connected to an intermediate tap CT of the feedback winding NB of the transformer T1.

Now, operation of the cold cathode fluorescent tube lighting device 12 of such a configuration described as above is described hereinafter. First, a signal for setting the ON-time width for luminance adjustment is sent out from the dimmer 24 for luminance adjustment to the PWM control device 15X, and upon receipt of the signal, the PWM control device 15X controls the control pulse signal Scnt matching the signal for setting the ON-time width so as to be at the low level. When the control pulse signal Scnt is controlled at the low level, the switching element Q1 is shifted to the OFF state. Then, a divided voltage is generated through voltage division by the resistor R1, and the variable resistor RV1, and the divided voltage is applied to the respective gates of the switching elements Q2, Q3 as a bias voltage via the intermediate tap CT of the feedback winding NB, thereby turning ON the switching elements Q2, Q3. When the switching elements Q2, Q3 are turned ON, the voltage from the DC power source E is supplied to the primary winding N1 and the secondary winding N2 is caused to undergo excitation, thereby starting oscillation. In this connection, an expedient is adopted such that the switching elements Q2, Q3 are turned ON without being shifted abruptly to the ON-state in practice, thereby preventing the self-excited push-pull circuit 22 from causing unnecessary electrical oscillation and mechanical vibration, however, the expedient is omitted in description of the circuit.

In a state where the self-excited push-pull circuit 22 is once actuated, the self-excited push-pull circuit 22 continues self-excited oscillation by the agency of the bias voltage generated due to the OFF state of the switching element Q1 to be supplied to the respective gates of the switching elements Q2, Q3 via the intermediate tap CT of the feedback winding NB, and a voltage undergoing positive feedback to the respective gates of the switching elements Q2, Q3 via the feedback winding NB. As a result, the high AC voltage is induced in the secondary winding N2. Accordingly, the cold cathode fluorescent tube 11 receives the high AC voltage as induced, and can be lit up.

Thus, the luminance adjustment of the cold cathode fluorescent tube 11 is implemented by setting an ON/OFF duty ratio of the switching element Q1, in accordance with time when the control pulse signal Scnt from the PWM control circuit 15X turns Low by means of control by the dimmer 24 for luminance adjustment to thereby turn ON/OFF the oscillation operation of the self-excited push-pull circuit 22 [Patent Document 1] JP 2002-313595 A (pp. 5 to 6, FIG. 1)

### SUMMARY OF THE INVENTION

With the edge light method in backlighting, as described with reference to the first example of the conventional technology, however, there exists a problem in that it is impossible to implement luminance adjustment in a wide rage because in expanding a luminance adjustment range of the backlight comprising one unit of cold cathode fluorescent tube, that is, in increasing a dimming ratio (the maximum luminance/the minimum luminance), there are limitations to the maximum luminance capacity of the cold cathode fluorescent tube itself, and stable lighting at the minimum luminance.

Further, with the liquid crystal display device according to the second example of the conventional technology, the cold cathode fluorescent tube used as the backlight is lit up based on the following principle of light emission.

An inert gas and a trace quantity of mercury are sealed in the cold cathode fluorescent tube, and the inner wall of the glass tube is coated with a fluorescent substance. Electric discharge is started by applying a high voltage across electrodes disposed at respective tube face ends, thereby producing ultraviolet rays undergoing excitation due to collision of mercury with electrons, and atoms of the gas sealed. The ultraviolet rays cause excitation of a light emitting substance to be then converted into visible rays, thereby lighting up the cold cathode fluorescent tube.

Since mercury is used internally, temperature-dependent luminance characteristics of the cold cathode fluorescent tube have variation in luminance as shown hereunder.

Luminance reaches the peak at a tube face temperature in a range of 60° C. to 70° C. As a mercury vapor pressure inside the tube considerably decreases, and ultraviolet ray output drops on a lower temperature side of the tube, so does luminance on the lower temperature side.

When luminance adjustment is implemented, for example, from display at the maximum luminance to display at the minimum luminance, the tube face temperature of a lamp in the maximum luminance state is already high owing to the characteristics of the cold cathode fluorescent tube as described above, so that there exists a problem that it is impossible to instantaneously adjust luminance to the minimum luminance as desired even if the ON-time is rendered the shortest by PWM dimming control.

It is conceivable that ON-time corresponding to the smallest dimmer value may be set shorter, however, there exists another problem that if the smallest dimmer value is set when the tube face temperature is Low, lamp lighting becomes one-sided, thereby causing deterioration in luminance uniformity on a liquid crystal display face.

To take an example, a backlight of a liquid crystal display device used in an aircraft is under illuminating conditions ranging from a pitch-dark night state to such a state as exposed to the sunlight in the daytime, and should provide illumination that can be adjustable in a wide range so that display is visible to a pilot even under these conditions. Further, luminance should be rapidly adjustable to a desired luminance even when an ambient temperature of the device is 71° C.

In order to meet such requirements, there exist problems to be resolved with a technique capable of adjusting illumination by the backlight in a wide range, that is, increasing a dimming ratio (the maximum luminance/the minimum luminance) of luminance on the display face.

To resolve those problems, the present invention provides a liquid crystal display method and a liquid crystal display device, having the following configuration.

(1) A liquid crystal display method wherein backlights of a liquid crystal display panel are set up by a plurality of cold cathode fluorescent tubes, and duty control of the plurality of the cold cathode fluorescent tubes is effected individually to thereby implement luminance adjustment between the minimum luminance and the maximum luminance.

(2) The liquid crystal display method described under item (1) as above, wherein in the case of the plurality of the cold cathode fluorescent tubes being two units of the cold cathode fluorescent tubes, the luminance adjustment is implemented such that the maximum luminance is obtained when both the cold cathode fluorescent tubes are controlled for ON-duty while the minimum luminance is obtained when luminance is adjusted by lessening ON-duty for one of the cold cathode fluorescent tubes, and subsequently, turning OFF the one of the cold cathode fluorescent tubes, followed by minimization of ON-duty for the other of the cold cathode fluorescent tubes.

(3) A liquid crystal display device comprising a liquid crystal display panel, cold cathode fluorescent tubes for irradiating the liquid crystal display panel with light, self-excited push-pull circuits for lighting up the cold cathode fluorescent tubes, respectively, gate bias voltage supply circuits for generating a signal for applying a high AC voltage to the cold cathode fluorescent tubes against the self-excited push-pull circuits, respectively, PMW control means for providing the gate bias voltage supply circuits with ON-duty signals, respectively, wherein the cold cathode fluorescent tubes include a plurality of the cold cathode fluorescent tubes, and the plurality of the cold cathode fluorescent tubes each are provided with the self-excited push-pull circuit, the gate bias voltage supply circuit, and the PMW control means, against the respective PMW control means, a dimming controller being provided for supplying signals to cause the cold cathode fluorescent tubes to discharge, respectively.

(4) The liquid crystal display device described under item (3) as above, wherein in the case of the plurality of the cold cathode fluorescent tubes being two units of the cold cathode fluorescent tubes, the dimming controller controls such that the maximum luminance is obtained by the ON-duty signals outputted by the respective PMW control means for controlling the two units of cold cathode fluorescent tubes while the minimum luminance is obtained when luminance is adjusted by lessening ON-duty for one of the cold cathode fluorescent tubes, and subsequently, turning OFF the one of the cold cathode fluorescent tubes, followed by control of ON-duty for the other of the cold cathode fluorescent tubes.

(5) A liquid crystal display device comprising a liquid crystal display panel, cold cathode fluorescent tubes for irradiating the liquid crystal display panel with light, self-excited push-pull circuits for lighting up the cold cathode fluorescent tubes, respectively, gate bias voltage supply circuits for generating a signal for applying a high AC voltage to the cold cathode fluorescent tubes against the self-excited push-pull circuits, respectively, PMW control means for providing the gate bias voltage supply circuits with ON-duty signals, respectively, wherein the PMW control means each control an ON-duty signal on the basis of luminance data from an internal optical sensor set up in the cold cathode fluorescent tube.

(6) The liquid crystal display device described under item (3) as above, further comprising a thermistor for measuring temperature of the cold cathode fluorescent tube, and control means for controlling a fan for cooling the cold cathode fluorescent tube on the basis of temperature data from the thermistor.

The backlight of the liquid crystal display device for use as, for example, an aircraft liquid crystal display device, under illuminating conditions ranging from a pitch-dark night state to such a state as exposed to the sunlight in the daytime, is capable of rendering display visible to a pilot even under these conditions, and has a configuration enabling illumination adjustable in a wide range when used in the aircraft liquid crystal display device. More specifically, it is possible to obtain a dimming ratio in a range corresponding to a dimming ratio of a single lamp, multiplied by the number of lamp systems employed.

Further, for example, with the backlight described, used for the aircraft liquid crystal display device, it is possible to rapidly implement luminance adjustment without causing one-sided lighting even under various illuminating conditions in a wide range from the pitch-dark night state to the state as exposed to the sunlight in the daytime, and even in an environment where an ambient temperature is 71° C.

### BRIEF DESCRIPTION OF THE DRAWINGS

FIG. 1 is a circuit diagram of a first embodiment of a liquid crystal display device according to the invention;

FIG. 2 is a block diagram of a liquid crystal display panel of the liquid crystal display device in FIG. 1;

FIG. 3 is a circuit diagram of a second embodiment of a liquid crystal display device according to the invention;

FIG. 4 is a circuit diagram of a third embodiment of a liquid crystal display device according to the invention;

FIG. 5 is a circuit diagram of a fourth embodiment of a liquid crystal display device according to the invention;

FIG. 6 is a circuit diagram of a liquid crystal display device according to a first example of the conventional technology;

FIG. 7 is a block diagram of a liquid crystal display panel of the liquid crystal display device in FIG. 3; and

FIG. 8 is a circuit diagram of a liquid crystal display device according to a second example of the conventional technology.

### PREFERRED EMBODIMENT OF THE INVENTION

Embodiments of a liquid crystal display device according to the invention are described in detail hereinafter with reference to the accompanying drawings. Parts identical to those described with reference to the conventional technology are denoted by like reference numerals.

### First Embodiment

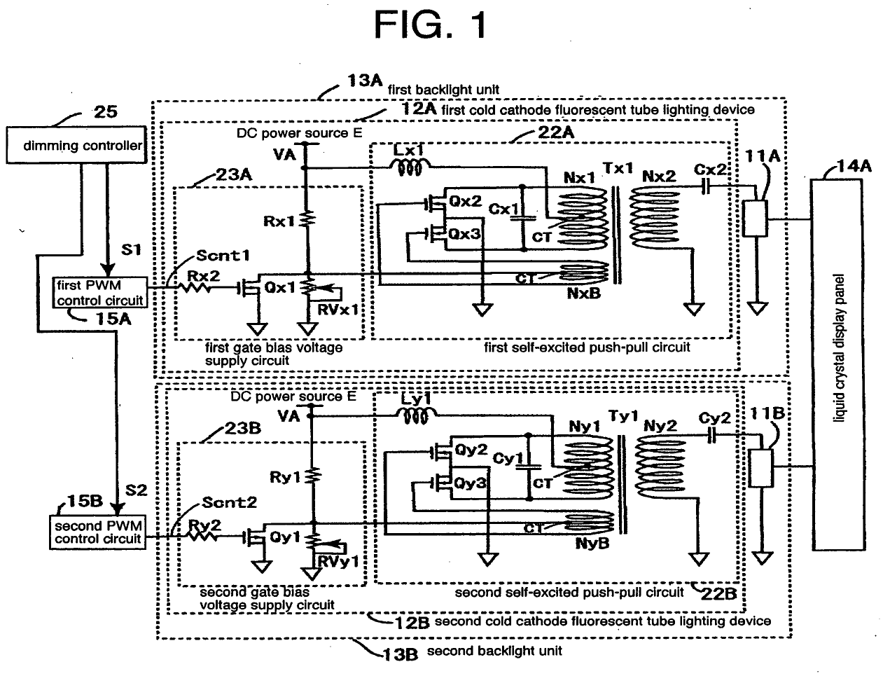

In contrast to a conventional liquid crystal display device employing one unit of cold cathode fluorescent tube, a liquid crystal display device according to the first embodiment of the invention employs two units of cold cathode fluorescent tubes, and the two cold cathode fluorescent tubes each are provided with a cold cathode fluorescent tube lighting device, and a PWM control circuit to thereby cause a dimming controller to control the device in whole. As shown in FIG. 1, the liquid crystal display device comprises a first backlight unit 13A comprised of a first cold cathode fluorescent tube lighting device 12A and a first cold cathode fluorescent tube 11A, a second backlight unit 13B comprised of a second cold cathode fluorescent tube lighting device 12B and a second cold cathode fluorescent tube 11B, a liquid crystal display panel 14A using the first and second backlight units 13A, 13B, as light sources thereof, a first PWM control circuit 15A for executing operation control of the first backlight unit 13A, a second PWM control circuit 15B for executing operation control of the second backlight unit 13B, and a dimming controller 25 for controlling the first and second PWM control circuits 15A, 15B, respectively.

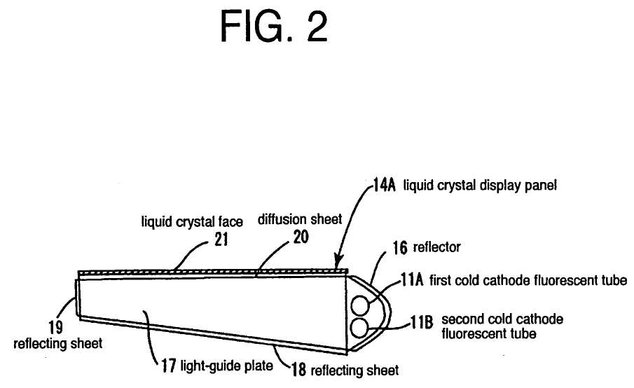

As shown in FIG. 2, the liquid crystal display panel 14A comprises two cold cathode fluorescent tubes, that is, the first cold cathode fluorescent tube 11A and the second cold cathode fluorescent tube 11B, serving as backlights, respectively, a light-guide plate 17 on which light emitted from the first cold cathode fluorescent tube 11A and the second cold cathode fluorescent tube 11B, respectively, fall from one side, a reflector 16 for causing the light from the first cold cathode fluorescent tube 11A and the second cold cathode fluorescent tube 11B, respectively, to be reflected toward the light-guide plate 17, reflecting sheets 18, 19, disposed at a position underneath the light-guide plate 17, and at a position opposite from the first and second cold cathode fluorescent tubes 11A, 11B, in a direction in which respective incident light from the first cold cathode fluorescent tube 11A and the second cold cathode fluorescent tube 11B are guided, respectively, for causing the light propagating along the light-guide plate 17 to be reflected upward, a diffusion sheet 20 provided at a position above the light-guide plate 17, for causing the light from the light-guide plate 17 to be diffused, and a liquid crystal face 21 disposed over the diffusion sheet 20.

In the case of the light from the backlights of a configuration described as above, the light emitted from the first cold cathode fluorescent tube 11A and the second cold cathode fluorescent tube 11B, respectively, are first condensed by the reflector 16 to be then caused to fall on the light-guide plate 17. Light falling on the light-guide plate 17 is reflected upward in the figure by the reflecting sheets 18, 19. The light as reflected is turned into homogeneous light by the diffusion sheet 20 before falling on the liquid crystal face 21.

The first PWM control circuit 15A shown in FIG. 1 is capable of adjusting luminance of the first cold cathode fluorescent tube 11A by means of a dimming method for effecting ON-duty control by pulse width modulation, and generates a first control pulse signal Scnt1 for luminance adjustment on the basis of a control signal S1 from the dimming controller 25 to be then delivered to the first cold cathode fluorescent tube lighting device 12A.

The first cold cathode fluorescent tube lighting device 12A is connected to the first cold cathode fluorescent tube 11A, and when the first control pulse signal Scnt1 for ON-duty, at the low level, is received from the first PWM control circuit 15A, a DC voltage VA supplied from a DC power source E is divided by resistors Rx1, RVx1, and a divided voltage as generated is applied to respective gate of FETs Qx2, Qx3 as a bias voltage via an intermediate tap CT of a feedback winding NB, whereupon a first self-excited push-pull circuit 22A actuates oscillation to thereby convert the divided voltage into a high AC voltage, according to a winding ratio of transformer Tx1, and the high AC voltage as converted is supplied to the first cold cathode fluorescent tube 11A, to thereby light up the cold cathode fluorescent tube controller 11A.

More specifically, the first cold cathode fluorescent tube lighting device 12A comprises the DC power source E for generating the DC voltage at a voltage VA, a first gate bias voltage supply circuit 23A, and the first self-excited push-pull circuit 22A including the transformer Tx1, an inductor Lx1, capacitors Cx1, Cx2, and a pair of the n-channel FETs (switching elements) Qx2, Qx3.

The transformer Nx1 as a constituent of the first self-excited push-pull circuit 22A is provided with a primary winding Nx1 having an intermediate tap CT, a secondary winding Nx2, and the feedback winding Nx1, and the secondary winding Nx2 has one end grounded, and the other end coupled to one end of the capacitor Cx2. The capacitor Cx2 has the other end coupled to the first cold cathode fluorescent tube 11A. The inductor Lx1 is an element for causing the DC power source E to function as a constant current source, interconnecting the DC power source E and the intermediate tap CT of the primary winding Nx1 of the transformer Tx1. Respective drains of the switching elements Qx2, Qx3 are connected to respective ends of the primary winding Nx1, and respective gates thereof are connected to respective ends of the feedback winding NxB. With such a circuit configuration as described, an oscillation frequency of the first self-excited push-pull circuit 22A is dependent primarily on the capacitor Cx1 coupled in parallel to the primary winding Nx1 of the transformer Tx1, and inductance of the primary winding Nx1 of the transformer Tx1.

The first gate bias voltage supply circuit 23A has the function of supplying the bias voltage to the respective gates of the switching elements Qx2, Qx3, and adjusting luminance of the first cold cathode fluorescent tube 11A in accordance with the first control pulse signal Scnt1 as inputted, and a switching element Qx1 connected to the first PWM control circuit 15 via a resistor Rx2 and an output end of the first gate bias voltage supply circuit 23A are connected to a node where the DC voltage undergoes voltage division by the resistor Rx1, and the variable resistor RVx1, further the output end being connected to the intermediate tap CT of the feedback winding NxB of the transformer Tx1.

The second PWM control circuit 15B is capable of adjusting luminance of the second cold cathode fluorescent tube 11B by means of the dimming method for effecting ON-duty control by pulse width modulation, and generates a second control pulse signal Scnt2 for luminance adjustment on the basis of a control signal S2 from the dimming controller 25 to be then delivered to the second cold cathode fluorescent tube lighting device 12B.

The second cold cathode fluorescent tube lighting device 12B is connected to the second cold cathode fluorescent tube 11B, and when the second control pulse signal Scnt2 for ON-duty, at the low level, is received from the second PWM control circuit 15B, a DC voltage VA supplied from the DC power source E is divided, and a divided voltage is applied to respective gate of switching elements Qy2, Qy3 as a bias voltage, whereupon a second self-excited push-pull circuit 22B actuates oscillation to thereby generate a high AC voltage on a secondary winding side of a transformer Ty1, according to a winding ratio of the transformer Ty1, and the high AC voltage as converted is supplied to the second cold cathode fluorescent tube 11B, to thereby light up the cold cathode fluorescent tube controller 11B.

More specifically, the second cold cathode fluorescent tube lighting device 12B comprises the DC power source E for generating the DC voltage at a voltage VA, a second gate bias voltage supply circuit 23B, and the second self-excited push-pull circuit 22B including the transformer Ty1, an inductor Ly1, capacitors Cy1, Cy2, and a pair of the n-channel FETs (switching elements) Qy2, Qy3.

The transformer Ty1 as a constituent of the second self-excited push-pull circuit 22B is provided with a primary winding Ny1 having the intermediate tap CT, a secondary winding Ny2, and a feedback winding NyB, and the secondary winding Ny2 has one end grounded, and the other end coupled to one end of the capacitor Cy2. The capacitor Cy2 has the other end coupled to the second cold cathode fluorescent tube 11B. The inductor Ly1 is an element for causing the DC power source E to function as a constant current source, interconnecting the DC power source E and an intermediate tap CT of the primary winding Ny1 of the transformer Ty1. Respective drains of the switching elements Qy2, Qy3 are connected to respective ends of the primary winding Ny1, and respective gates thereof are connected to respective ends of the feedback winding NyB. With such a circuit configuration as described, an oscillation frequency of the second self-excited push-pull circuit 22B is dependent primarily on the capacitor Cy1 coupled in parallel to the primary winding Ny1 of the transformer Ty1, and inductance of the primary winding Ny1 of the transformer Ty1.

A second gate bias voltage supply circuit 23B has the function of supplying a gate bias voltage to the switching elements Qy2, Qy3, respectively, and adjusting luminance of the second cold cathode fluorescent tube 11B in accordance with the second control pulse signal Scnt2 as inputted, and a switching element Qy1 connected to the second PWM control circuit 15B via a resistor Ry2 and an output end of the second gate bias voltage supply circuit 23B are connected to a node where the DC voltage is divided by a resistor Ry1, and a variable resistor RVy1, further the output end being connected to an intermediate tap CT of the feedback winding NyB of the transformer Ty1.

Now, operation of the liquid crystal display device of such a configuration described as above is described hereinafter by referring to the first backlight unit 13A. First, when the first PWM control circuit 15A receives the control signal Si from the dimming controller 25, and the first control pulse signal Scnt1 is controlled Low, the switching element Qx1 is shifted to the OFF-state. Then, the voltage divided by the resistor Rx1, and the variable resistor RVx1 is generated, and the divided voltage as generated is applied to the respective gates of the switching elements Qx2, Qx3 as the bias voltage via the feedback winding, thereby turning ON the switching elements Qx2, Qx3. When the switching elements Qx2, Qx3 are turned ON, the voltage from the DC power source E is supplied to the primary winding to thereby cause the secondary winding to undergo excitation, whereupon the first self-excited push-pull circuit 22A actuates oscillation. In this connection, an expedient is adopted such that the switching elements Qx2, Qx3 are turned ON without being shifted abruptly to the ON-state in practice, thereby preventing the second self-excited push-pull circuit 22A from causing unnecessary electrical oscillation and mechanical vibration, however, the expedient is omitted in description of the circuit.

In a state where the first self-excited push-pull circuit 22A is once actuated, the first self-excited push-pull circuit 22A continues self-excited oscillation by the agency of the bias voltage supplied to the respective gates of the switching elements Qx2, Qx3 via the feedback winding NxB on the basis of the ON-state of the switching element Qx1, and a voltage undergoing positive feedback to the respective gates of the switching elements Qx2, Qx3 via the feedback winding NxB. As a result, the high AC voltage is induced in the secondary winding Nx2. Accordingly, the first cold cathode fluorescent tube 11A receives the high AC voltage as induced, and can be lit up.

Similarly, with the second backlight unit 13B as well, the second cold cathode fluorescent tube 11B is lit up by the agency of the control signal S2 from the dimming controller 25. First, when the second PWM control circuit 15B receives the control signal S2 from the dimming controller 25, and the second control pulse signal Scnt2 is controlled at the low level, the switching element Qy1 is shifted to the OFF-state. Then, the voltage divided by the resistor Ry1, and the variable resistor RVy1 is generated, and the divided voltage as generated is applied to respective gates of the switching elements Qy2, Qy3 as the bias voltage via the feedback winding NyB, thereby turning ON the switching elements Qy2, Qy3. When the switching elements Qy2, Qy3 are turned ON, the voltage from the DC power source E is supplied to the primary winding Ny1 to thereby cause the secondary winding Ny2 to undergo excitation, whereupon the second self-excited push-pull circuit 22B actuates oscillation. In this connection, an expedient is adopted such that the switching elements Qy2, Qy3 are turned ON without being shifted abruptly to the ON-state in practice, thereby preventing the second self-excited push-pull circuit 22B from causing unnecessary electrical oscillation and mechanical vibration, however, the expedient is omitted in description of the circuit.

In a state where the second self-excited push-pull circuit 22B is once actuated, the second self-excited push-pull circuit 22B continues self-excited oscillation by the agency of the bias voltage supplied to the respective gates of the switching elements Qy2, Qy3 via the feedback winding NyB on the basis of the ON-state of the switching element Qy1, and a voltage undergoing positive feedback to the respective gates of the switching elements Qy2, Qy3 via the feedback winding NyB. As a result, the high AC voltage is induced in the secondary winding Ny2. Accordingly, the second cold cathode fluorescent tube 11B receives the high AC voltage as induced, and can be lit up.

Thus, respective luminance adjustments of the first and second cold cathode fluorescent tubes 11A, 11B are implemented by turning ON/OFF respective oscillation operations of the first and second self-excited push-pull circuits 22A, 22B, according to respective ON/OFF duty ratios of the switching elements Qx1, Qy1, dependent on the first and second PWM control circuits 15A, 15B, respectively.

In connection with such respective luminance adjustments, there is described hereinafter the case where the luminance is adjusted from the maximum luminance to the minimum luminance.

(1) First, for display at the maximum luminance, the first and second self-excited push-pull circuits 22A, 22B each actuate oscillation upon receipt of the control signals S1, S2 from the dimming controller 25, respectively, and keep the first and second cold cathode fluorescent tubes 11A, 11B, in the ON-state, respectively, all the time, to thereby light up the cold cathode fluorescent tubes 11A, 11B at the maximum luminance.

(2) Then, in the case of reducing luminance by dimming, a duty ratio of either of the backlight systems, for example, a duty ratio of the first PWM control circuit 15A is rendered smaller by the agency of the control signal S1 for the first backlight unit 13A to thereby reduce luminance so as to effect lighting at the minimum luminance corresponding to the lower luminance limit of the first cold cathode fluorescent tube 11A. In such a case, the control signal S2 for the second backlight unit 13B is in the ON-state all the time, so that the second cold cathode fluorescent tube 11B is lit up at the maximum luminance at this point in time. In this case, a ratio of the minimum luminance to the maximum luminance, at a single cold cathode fluorescent tube, is designated as X.

(3) In the case of implementing further dimming, the first control pulse signal Scnt1 of the first PWM control circuit 15A is turned OFF by the agency of the control signal S1 from the dimming controller 25 to thereby turn OFF lighting of the first cold cathode fluorescent tube 11A while rendering a duty ratio of the second PWM control circuit 15B smaller by the agency of the other control signal S2 to thereby reduce luminance so as to effect lighting at the minimum luminance corresponding to the lower luminance limit of the second cold cathode fluorescent tube 11B. Because the cold cathode fluorescent tubes in use are identical to each other, the ratio of the minimum luminance to the maximum luminance, at either of the first and second cold cathode fluorescent tubes 11A, 11B, is X.

With the adoption of the backlight employing two units of the cold cathode fluorescent tubes as described in the foregoing, the dimming ratio becomes X², so that luminance at the liquid crystal face can be adjusted in a wider range as compared with the case of the backlight of the conventional configuration.

Further, in the case of implementing luminance adjustment from the minimum luminance to the maximum luminance, it will suffice to execute operation reverse to the operation described in the foregoing.

### Second Embodiment

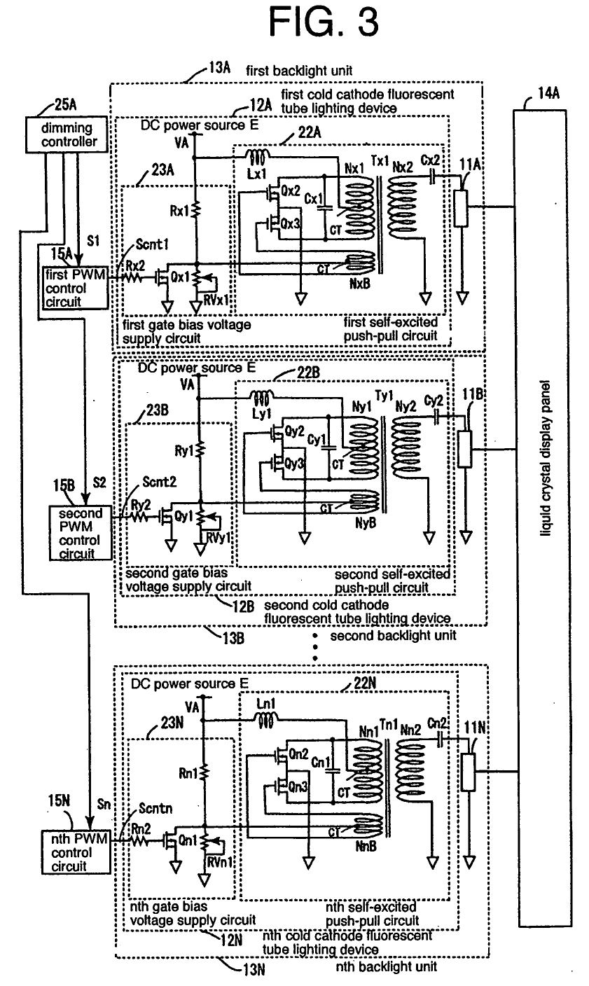

A liquid crystal display device according to the second embodiment of the invention is described with reference to FIG. 3.

In contrast to a conventional liquid crystal display device employing one unit of cold cathode fluorescent tube, the liquid crystal display device according to the second embodiment of the invention employs n-units of cold cathode fluorescent tubes, and the n-units of cold cathode fluorescent tubes each are provided with a cold cathode fluorescent tube lighting device, and a PWM control circuit to thereby cause a dimming controller to control the device in whole. As shown in FIG. 3, the liquid crystal display device comprises a first backlight unit 13A comprised of a first cold cathode fluorescent tube lighting device 12A and a first cold cathode fluorescent tube 11A, a second backlight unit 13B comprised of a second cold cathode fluorescent tube lighting device 12B and a second cold cathode fluorescent tube 11B, an nth backlight unit 13N comprised of an nth cold cathode fluorescent tube lighting device 12N and an nth cold cathode fluorescent tube 11N, a liquid crystal display panel 14A using the first, second˜nth backlight units 13A, 13B, . . . 13N as light sources thereof, a first PWM control circuit 15A for executing operation control of the first backlight unit 13A, a second PWM control circuit 15B for executing operation control of the second backlight unit 13B, an nth PWM control circuit 15N for executing operation control of the nth backlight unit 13N, and a dimming controller 25A for controlling the first, second˜nth PWM control circuits 15A, 15B, . . . 15N, respectively.

The liquid crystal display panel 14 is the same in configuration as that described with reference to the first embodiment, as shown in FIG. 2, but only the difference therebetween resides in that the two units of the cold cathode fluorescent tubes of the first embodiment are replaced by the n-units of the cold cathode fluorescent tubes, omitting therefore description thereof.

The first PWM control circuit 15A is capable of adjusting luminance of the first cold cathode fluorescent tube 11A by means of a dimming method for effecting ON-duty control by pulse width modulation, and generates a first control pulse signal Scnt1 for luminance adjustment on the basis of a control signal S1 from the dimming controller 25A to be then delivered to the first cold cathode fluorescent tube lighting device 12A.

The first cold cathode fluorescent tube lighting device 12A is connected to the first cold cathode fluorescent tube 11A, and a DC voltage VA supplied from a DC power source E is divided by resistors Rx1, RVx1, when the first cold cathode fluorescent tube lighting device 12A receives the first control pulse signal Scnt1, at the low level, from the first PWM control circuit 15A, and respective gate voltages of the FETs (Qx2, Qx3) are biased by a divided voltage as generated via an intermediate tap CT of a feedback winding NxB of a transformer Tx1, whereupon a first self-excited push-pull circuit 22A actuates oscillation to thereby convert the divided voltage into a high AC voltage, and the high AC voltage as converted is supplied to the first cold cathode fluorescent tube 11A, to thereby light up the cold cathode fluorescent tube controller 11A.

More specifically, the first cold cathode fluorescent tube lighting device 12A comprises the DC power source E for generating the DC voltage at a voltage VA, a first gate bias voltage supply circuit 23A, and the first self-excited push-pull circuit 22A including the transformer Tx1, an inductor Lx1, capacitors Cx1, Cx2, and a pair of the n-channel FETs (switching elements) Qx2, Qx3.

The transformer Tx1 as a constituent of the first self-excited push-pull circuit 22A is provided with a primary winding Nx1 having the intermediate tap CT, a secondary winding Nx2, and the feedback winding NxB, and the secondary winding Nx2 has one end grounded, and the other end coupled to one end of the capacitor Cx2. The capacitor Cx2 has the other end coupled to the first cold cathode fluorescent tube 11A. The inductor Lx1 is an element for causing the DC power source E to function as a constant current source, interconnecting the DC power source E and the intermediate tap CT of the primary winding Nx1 of the transformer Tx1. Respective drains of the switching elements Qx2, Qx3 are connected to respective ends of the primary winding Nx1, and respective gates thereof are connected to respective ends of the feedback winding NxB. With such a circuit configuration as described, an oscillation frequency of the first self-excited push-pull circuit 22A is dependent primarily on the capacitor Cx1 coupled in parallel to the primary winding Nx1 of the transformer Tx1, and inductance of the primary winding Nx1 of the transformer Tx1.

The first gate bias voltage supply circuit 23A has the function of supplying the bias voltage to the respective gates of the switching elements Qx2, Qx3, and adjusting luminance of the first cold cathode fluorescent tube 11A in accordance with the first control pulse signal Scnt1 as inputted, and a switching element Qx1 connected to the first PWM control circuit 15 via a resistor Rx2 and an output end of the first gate bias voltage supply circuit 23A are connected to a node where the DC voltage undergoes voltage division by the resistor Rx1, and the variable resistor RVx1, further the output end being connected to the intermediate tap CT of the feedback winding NxB of the transformer Tx1.

The second PWM control circuit 15B is capable of adjusting luminance of the second cold cathode fluorescent tube 11B by means of the dimming method for effecting ON-duty control by pulse width modulation, and generates a second control pulse signal Scnt2 for luminance adjustment on the basis of a control signal S2 from the dimming controller 25 to be then delivered to the second cold cathode fluorescent tube lighting device 12B.

The second cold cathode fluorescent tube lighting device 12B is connected to the second cold cathode fluorescent tube 11B, and when the second control pulse signal Scnt2 for ON-duty, at the low level, is received from the second PWM control circuit 15B, a DC voltage VA supplied from the DC power source E is divided by resistors Ry1, RVy1, and respective gate voltages of the FETs (Qy2, Qy3) are biased by a divided voltage as generated via an intermediate tap CT of a feedback winding NyB of a transformer Ty1, whereupon a second self-excited push-pull circuit 22B actuates oscillation to thereby convert the divided voltage into a high AC voltage, and the high AC voltage as converted is supplied to the second cold cathode fluorescent tube 11B, to thereby light up the cold cathode fluorescent tube controller 11B.

More specifically, the second cold cathode fluorescent tube lighting device 12B comprises the DC power source E for generating the DC voltage at a voltage VA, a second gate bias voltage supply circuit 23B, and the second self-excited push-pull circuit 22B including the transformer Ty1, an inductor Ly1, capacitors Cy1, Cy2, and a pair of the n-channel FETs (switching elements) Qy2, Qy3.

The transformer Ty1 as a constituent of the second self-excited push-pull circuit 22B is provided with a primary winding Ny1 having the intermediate tap CT, a secondary winding Ny2, and a feedback winding NyB, and the secondary winding Ny2 has one end grounded, and the other end coupled to one end of the capacitor Cy2. The capacitor Cy2 has the other end coupled to the second cold cathode fluorescent tube 11B. The inductor Ly1 is an element for causing the DC power source E to function as a constant current source, interconnecting the DC power source E and the intermediate tap CT of the primary winding Ny1 of the transformer Ty1. Respective drains of the switching elements Qy2, Qy3 are connected to respective ends of the primary winding Ny1, and respective gates thereof are connected to respective ends of the feedback winding NyB. With such a circuit configuration as described, an oscillation frequency of the second self-excited push-pull circuit 22B is dependent primarily on the capacitor Cy1 coupled in parallel to the primary winding Ny1 of the transformer Ty1, and inductance of the primary winding Ny1 of the transformer Ty1.

A second gate bias voltage supply circuit 23B has the function of supplying a gate bias voltage to the switching elements Qy2, Qy3, respectively, and adjusting luminance of the second cold cathode fluorescent tube 11B in accordance with the second control pulse signal Scnt2 as inputted, and a switching element Qy1 connected to the second PWM control circuit 15B via a resistor Ry2 and an output end of the second gate bias voltage supply circuit 23B are connected to a node where the DC voltage is divided by a resistor Ry1, and a variable resistor RVy1, further the output end being connected to an intermediate tap CT of the feedback winding NyB of the transformer Ty1.

The nth PWM control circuit 15N is capable of adjusting luminance of the nth cold cathode fluorescent tube 11N by means of the dimming method by pulse width modulation, and generates an nth control pulse signal Scntn for luminance adjustment on the basis of a control signal Sn from the dimming controller 25A to be then delivered to the nth cold cathode fluorescent tube lighting device 12N.

The nth cold cathode fluorescent tube lighting device 12N is connected to the nth cold cathode fluorescent tube 11N, and when the nth control pulse signal Scntn for ON-duty, at the low level, is received from the nth PWM control circuit 15N, a DC voltage VA supplied from the DC power source E is divided by resistors Rn1, RVn1, and respective gate voltages of the FETs (Qn2, Qn3) are biased by a divided voltage as generated via an intermediate tap CT of a feedback winding NnB of a transformer Tn1, whereupon an nth self-excited push-pull circuit 22N actuates oscillation to thereby, convert the divided voltage into a high AC voltage, and the high AC voltage as converted is supplied to the nth cold cathode fluorescent tube 11N, to thereby light up the cold cathode fluorescent tube controller 11N.

More specifically, the nth cold cathode fluorescent tube lighting device 12N comprises the DC power source E for generating the DC voltage at a voltage VA, an nth gate bias voltage supply circuit 23N, and the nth self-excited push-pull circuit 22N including the transformer Tn1, an inductor Ln1, capacitors Cn1, Cn2, and a pair of the n-channel FEAT (switching elements) Qn2, Qn3.

The transformer Tn1 as a constituent of the nth self-excited push-pull circuit 22N is provided with a primary winding Nn1 having the intermediate tap CT, a secondary winding Nn2, and a feedback winding NnB, and the secondary winding Nn2 has one end grounded, and the other end coupled to one end of the capacitor Cn2. The capacitor Cn2 has the other end coupled to the nth cold cathode fluorescent tube 11N. The inductor Ln1 is an element for causing the DC power source E to function as a constant current source, interconnecting the DC power source E and the intermediate tap CT of the primary winding Nn1 of the transformer Th1. Respective drains of the switching elements Qn2, Qn3 are connected to respective ends of the primary winding Nn1, and respective gates thereof are connected to respective ends of the feedback winding NnB. With such a circuit configuration as described, an oscillation frequency of the nth self-excited push-pull circuit 22N is dependent primarily on the capacitor Cn1 coupled in parallel to the primary winding Nn1 of the transformer Tn1, and inductance of the primary winding Nn1 of the transformer Tn1.

An nth gate bias voltage supply circuit 23N has the function of supplying a gate bias voltage to the switching elements Qn2, Qn3, respectively, and adjusting luminance of the nth cold cathode fluorescent tube 11N in accordance with the nth control pulse signal Scntn as inputted, and a switching element Qn1 connected to the nth PWM control circuit 15N via a resistor Rn2 and an output end of the nth gate bias voltage supply circuit 23N are connected to a node where the DC voltage is divided by a resistor Rn1, and a variable resistor RVn1, further the output end being connected to the intermediate tap CT of the feedback winding NnB of the transformer Tn1.

Now, operation of the liquid crystal display device of such a configuration described as above is described hereinafter by referring to the first backlight unit 13A. First, when the first PWM control circuit 15A receives the control signal S1 from the dimming controller 25A, and the first control pulse signal Scnt1 is controlled Low, the switching element Qx1 is shifted to the OFF-state. Then, the voltage divided by the resistor Rx1, and the variable resistor RVx1 is generated, and the divided voltage as generated is applied to the respective gates of the switching elements Qx2, Qx3 as the bias voltage via the intermediate CT of the feedback winding NxB, thereby turning ON either of the switching elements Qx2, Qx3. When either the switching element Qx2 or the switching element Qx3 is turned ON, oscillation is started by the agency of the inductance of the primary winding Nx1 of the transformer Tn1 and the capacitor Cx1. In this connection, an expedient is adopted such that the switching elements Qx2, Qx3 are turned ON without being shifted abruptly to the ON-state in practice, thereby preventing the first self-excited push-pull circuit 22A from causing unnecessary electrical oscillation and mechanical vibration, however, the expedient is omitted in description of the circuit.

In a state where the first self-excited push-pull circuit 22A is once actuated, the first self-excited push-pull circuit 22A continues self-excited oscillation by the agency of the bias voltage supplied to the respective gates of the switching elements Qx2, Qx3 via the feedback winding NxB on the basis of the ON-state of the switching element Qx1, and a voltage undergoing positive feedback to the respective gates of the switching elements Qx2, Qx3 via the feedback winding NxB. As a result, the high AC voltage is induced in the secondary winding Nx2. Accordingly, the first cold cathode fluorescent tube 11A receives the high AC voltage as induced, and can be lit up.

Similarly, with the second backlight unit 13B as well, the second cold cathode fluorescent tube 11B is lit up by the agency of the control signal S2 from the dimming controller 25A. First, when the second PWM control circuit 15B receives the control signal S2 from the dimming controller 25A, and the second control pulse signal Scnt2 is controlled at the low level, the switching element Qy1 is shifted to the OFF-state. Then, the voltage divided by the resistor Ry1, and the variable resistor RVy1 is generated, and the divided voltage as generated is applied to respective gates of the switching elements Qy2, Qy3 as the bias voltage via the intermediate tap CT of the feedback winding NyB, thereby turning ON either of the switching elements Qy2, Qy3. When either the switching element Qy2 or the switching element Qy3 is turned ON, the oscillation is started by the agency of the inductance of the primary winding Ny1 of the transformer Ty1 and the capacitor Cy1. In this connection, an expedient is adopted such that the switching elements Qy2, Qy3 are turned ON without being shifted abruptly to the ON-state in practice, thereby preventing the second self-excited push-pull circuit 22B from causing unnecessary electrical oscillation and mechanical vibration, however, the expedient is omitted in description of the circuit.

In a state where the second self-excited push-pull circuit 22B is once actuated, the second self-excited push-pull circuit 22B continues self-excited oscillation by the agency of the bias voltage supplied to the respective gates of the switching elements Qy2, Qy3 via the feedback winding NyB on the basis of the ON-state of the switching element Qy1, and a voltage undergoing positive feedback to the respective gates of the switching elements Qy2, Qy3 via the feedback winding NyB. As a result, the high AC voltage is induced in the secondary winding Ny2. Accordingly, the second cold cathode fluorescent tube 11B receives the high AC voltage as induced, and can be lit up.

Similarly, with the nth backlight unit 13N as well, the nth cold cathode fluorescent tube 11N is lit up by the agency of the control signal Sn from the dimming controller 25A. First, when the nth PWM control circuit 15N receives the control signal Sn from the dimming controller 25A, and the nth control pulse signal Scntn is controlled at the low level, the switching element Qn1 is shifted to the OFF-state. Then, the voltage divided by the resistor Rn1, and the variable resistor RVn1 is generated, and the divided voltage as generated is applied to respective gates of the switching elements Qn2, Qn3 as the bias voltage via the intermediate tap CT of the feedback winding NnB, thereby turning ON either of the switching elements Qy2, Qy3. When either the switching element Qn2 or the switching element Qn3 is turned ON, the oscillation is started by the agency of the inductance of the primary winding Nn1 of the transformer Tn1 and the capacitor Cn1. In this connection, an expedient is adopted such that the switching elements Qn2, Qn3 are turned ON without being shifted abruptly to the ON-state in practice, thereby preventing the nth self-excited push-pull circuit 22N from causing unnecessary electrical oscillation and mechanical vibration, however, the expedient is omitted in description of the circuit.

In a state where the nth self-excited push-pull circuit 22N is once actuated, the nth self-excited push-pull circuit 22N continues self-excited oscillation by the agency of the bias voltage supplied to the respective gates of the switching elements Qn2, Qn3 via the feedback winding NnB on the basis of the ON-state of the switching element Qn1, and a voltage undergoing positive feedback to the respective gates of the switching elements Qn2, Qn3 via the feedback winding NnB. As a result, the high AC voltage is induced in the nth winding Nn2. Accordingly, the nth cold cathode fluorescent tube 11N receives the high AC voltage as induced, and can be lit up.

Thus, respective luminance adjustments of the first, second˜nth cold cathode fluorescent tubes 11A, 11B, . . . 11N are implemented by turning ON/OFF respective oscillation operations of the first, second˜nth self-excited push-pull circuits 22A, 22B, . . . 22N, according to respective ON/OFF duty ratios of the switching elements Qx1, Qy1-Qn1 dependent on the first, second-nth PWM control circuits 15A, 15B, . . . 15N, respectively.

In connection with such respective luminance adjustments, there is described hereinafter the case where the luminance is adjusted from the maximum luminance to the minimum luminance.

(1) First, for display at the maximum luminance, the first, second˜nth self-excited push-pull circuits 22A, 22B, . . . 22N each actuate oscillation upon receipt of the control signals S1, S2˜Sn from the dimming controller 25, respectively, and keep the first, second˜nth cold cathode fluorescent tubes 11A, 11B, . . . 11N in the ON-state, respectively, all the time, to thereby light up the cold cathode fluorescent 11A, 11B, . . . 11N at the maximum luminance.

(2) Then, in the case of reducing luminance by dimming, a duty ratio of either of the backlight systems, for example, a duty ratio of the first PWM control circuit 15A is rendered smaller by the agency of the control signal S1 for the first backlight unit 13A to thereby reduce luminance so as to effect lighting at the minimum luminance corresponding to the lower luminance limit of the first cold cathode fluorescent tube 11A. In such a case, the control signals S2˜Sn for the second˜nth backlight units 13B, . . . 13N are in the ON-state all the time, so that the second-nth cold cathode fluorescent tubes 11B, . . . 11N are lit up at the maximum luminance at this point in time. In this case, a ratio of the minimum luminance to the maximum luminance, at a single cold cathode fluorescent tube, is designated as X.

(3) In the case of implementing further dimming, the first control pulse signal Scnt1 of the first PWM control circuit 15A is turned OFF by the agency of the control signal S1 from the dimming controller 25A to thereby turn OFF lighting of the first cold cathode fluorescent tube 11A while rendering a duty ratio of the second PWM control circuit 15B smaller by the agency of the other control signal S2 to thereby reduce luminance so as to effect lighting at the minimum luminance corresponding to the lower luminance limit of the second cold cathode fluorescent tube 11B. In such a case, the control signal Sn for the nth backlight unit 13N in the ON-state all the time, so that the nth cold cathode fluorescent tube 11N is lit up at the maximum luminance at this point in time.

(4) In such a manner, the luminance can be reduced to the minimum luminance in a whole by gradually reducing the number of lit up cold cathode fluorescent tube with the repetition of reducing the luminance so as to effect lighting at the minimum luminance corresponding to the lower luminance limit of the cold cathode fluorescent tube after one of the cold cathode fluorescent tubes effects lighting at the minimum luminance, and subsequently turning OFF the one of the lighting of the cold cathode fluorescent tubes.

Because the cold cathode fluorescent tubes in use are identical to each other, the ratio of the minimum luminance to the maximum luminance, at the entire cold cathode fluorescent tubes, is X.

With the adoption of the backlight employing n-units of the cold cathode fluorescent tubes as described in the foregoing, the dimming ratio becomes X², SO that luminance at the liquid crystal face can be adjusted in a wider range as compared with the case of the backlight having one unit of cold cathode fluorescent tube of the conventional configuration.

Further, in the case of implementing luminance adjustment from the minimum luminance to the maximum luminance, it will suffice to execute operation reverse to the operation described in the foregoing.

### Third Embodiment

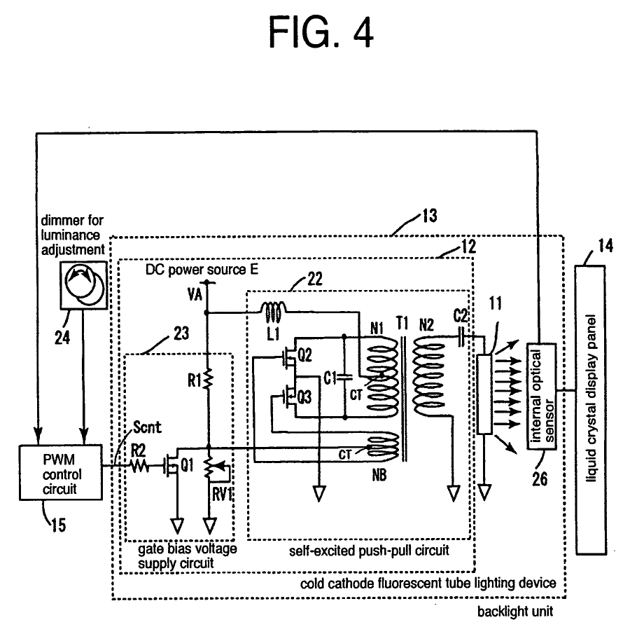

A liquid crystal display device according to the third embodiment of the invention is described with reference to FIG. 4.

The liquid crystal display device according to the third embodiment includes an internal optical sensor (illuminance sensor) added to be set up in the cold cathode fluorescent tube conventionally used for a backlight unit, thereby feed-backing luminance data to a PWM controller. Luminance adjustment of the cold cathode fluorescent tube is implemented by turning ON/OFF oscillation operation of a self-excited push-pull circuit considering luminance data thus fed back. As shown in FIG. 4, the liquid crystal display device comprises a backlight unit 13 comprised of a cold cathode fluorescent tube lighting device 12, a cold cathode fluorescent tube 11, and an internal optical sensor 26, a liquid crystal display panel 14 using the cold cathode fluorescent tube 11 of the backlight unit 13, as a light source thereof, a PWM control circuit 15 for executing operation control of the cold cathode fluorescent tube lighting device 12, and a dimmer 24 for luminance adjustment to control a control pulse signal Scnt sent out from a PWM control device 15.

The liquid crystal display panel 14 is the same in configuration as that described with reference to the conventional technology, as shown in FIG. 7, omitting therefore description thereof.

The PWM control circuit 15 is capable of adjusting luminance of the cold cathode fluorescent tube 11 by means of a dimming method by pulse width modulation, and generates a control pulse signal Scnt for luminance adjustment upon receipt of a signal from the dimmer 24 for luminance adjustment and luminance data from the internal optical sensor 26 to be then delivered to the cold cathode fluorescent tube lighting device 12.

More specifically, an ON/OFF duty control for generating the control pulse signal Scnt is executed by providing a table showing a dimmer value from the dimmer 24 for luminance adjustment and a luminance value relative to the dimmer value, which values are compared with a value of luminance data fed back from the internal optical sensor 26, thereby controlling the ON-time width.

The dimmer 24 for luminance adjustment is to control ON-time for luminance adjustment, controlling an ON-time width of the control pulse signal Scnt outputted from the PWM control device 15.

The cold cathode fluorescent tube lighting device 12 is connected to the cold cathode fluorescent tube 11, and when it receives the control pulse signal Scnt for ON-duty, at the low level, from the PWM control circuit 15, a DC voltage VA supplied from a DC power source E is divided by resistors R1, RV1, and respective gate voltages of FENs (Q2, Q3) are biased via an intermediate tap CT of a feedback winding NB of a transformer T1, whereupon a self-excited push-pull circuit 22 actuates oscillation to thereby convert the divided voltage into a high AC voltage, and the high AC voltage as converted is supplied to the cold cathode fluorescent tube 11, to thereby light up the cold cathode fluorescent tube controller 11.

More specifically, the cold cathode fluorescent tube lighting device 12 comprises the DC power source E for generating the DC voltage at a voltage VA, a gate bias voltage supply circuit 23, and the self-excited push-pull circuit 22 including the transformer T1, an inductor L1, capacitors C1, C2, and a pair of the n-channel FETs (switching elements) Q2, Q3.

The transformer T1 as a constituent of the self-excited push-pull circuit 22 is provided with a primary winding N1 having an intermediate tap CT, a secondary winding N2, and the feedback winding NB, and the secondary winding N2 has one end grounded, and the other end coupled to one end of the capacitor C2. The capacitor C2 has the other end coupled to the cold cathode fluorescent tube 11. The inductor L1 is an element for causing the DC power source E to function as a constant current source, interconnecting the DC power source E and the intermediate tap CT of the primary winding N1 of the transformer T1. Respective drains of the switching elements Q2, Q3 are connected to respective ends of the primary winding N1, and respective gates thereof are connected to respective ends of the feedback winding NB. With such a circuit configuration as described, an oscillation frequency of the self-excited push-pull circuit 22 is dependent primarily on the capacitor C1 coupled in parallel to the primary winding N1 of the transformer T1, and inductance of the primary winding N1 of the transformer T1.

The gate bias voltage supply circuit 23 has the function of supplying the bias voltage to the respective gates of the switching elements Q2, Q3, and adjusting luminance of the cold cathode fluorescent tube 11 in accordance with the control pulse signal Scnt as inputted, and a switching element Q1 connected to the PWM control circuit 15 via a resistor R2 and an output end of the gate bias voltage supply circuit 23 are connected to a node where the DC voltage undergoes voltage division by the resistor Rx1, and the variable resistor RV1, further the output end being connected to the intermediate tap CT of the feedback winding NB of the transformer T1.

Now, operation of the cold cathode fluorescent tube lighting device 12 of such a configuration described as above is described hereinafter. First, a signal for setting the ON-time width for luminance adjustment is sent out from the dimmer 24 for luminance adjustment and the value of luminance data fed back from the internal optical sensor 26 to the PWM control device 15, and upon receipt of these signals, the PWM control device 15 controls the control pulse signal Scnt matching the signal for setting the ON-time width so as to be at the low level. When the control pulse signal Scnt is controlled at the low level, the switching element Q1 is shifted to the OFF state. Then, a divided voltage is generated through voltage division by the resistor R1, and the variable resistor RV1, and the divided voltage is applied to the respective gates of the switching elements Q2, Q3 as a bias voltage via the intermediate tap CT of the feedback winding NB, thereby turning ON either of the switching elements Q2, Q3. When either the switching element Q2 or the switching element Q3 is turned ON, oscillation is started by the agency of the inductance of the primary winding N1 of the transformer T1 and the capacitor C1. In this connection, an expedient is adopted such that the switching elements Q2, Q3 are turned ON without being shifted abruptly to the ON-state in practice, thereby preventing the self-excited push-pull circuit 22 from causing unnecessary electrical oscillation and mechanical vibration, however, the expedient is omitted in description of the circuit.

In a state where the self-excited push-pull circuit 22 is once actuated, the self-excited push-pull circuit 22 continues self-excited oscillation by the agency of the bias voltage generated due to the ON state of the switching element Q1 to be supplied to the respective gates of the switching elements Q2, Q3 via the feedback winding NB, and a voltage undergoing positive feedback to the respective gates of the switching elements Q2, Q3 via the feedback winding NB. As a result, the high AC voltage is induced in the secondary winding N2. Accordingly, the cold cathode fluorescent tube 11 receives the high AC voltage as induced, and can be lit up.

Thus, it is possible to consider the change of characteristics caused by the temperature of the controller 11 by setting an ON/OFF duty ratio of the switching element Q1, in accordance with time when the control pulse signal Scnt from the PWM control circuit 15 turns Low with reference to luminance data fed back from the internal optical sensor 26 in addition to the control by the dimmer 24 for luminance adjustment, so that the luminance can be adjusted to the minimum luminance even at any tube face temperature without causing one-sided lighting.

Further, for example, with the backlight described, used for the aircraft liquid crystal display device, it is possible to rapidly implement luminance adjustment without causing one-sided lighting even under various illuminating conditions in a wide range from the pitch-dark night state to the state as exposed to the sunlight in the daytime, and even in an environment where an ambient temperature is 71° C. by subjecting the self-excited push-pull circuit 22 to ON/OFF control while the luminance data from the internal optical sensor set up in the vicinity of the cold cathode fluorescent tube His fed back.

### Fourth Embodiment

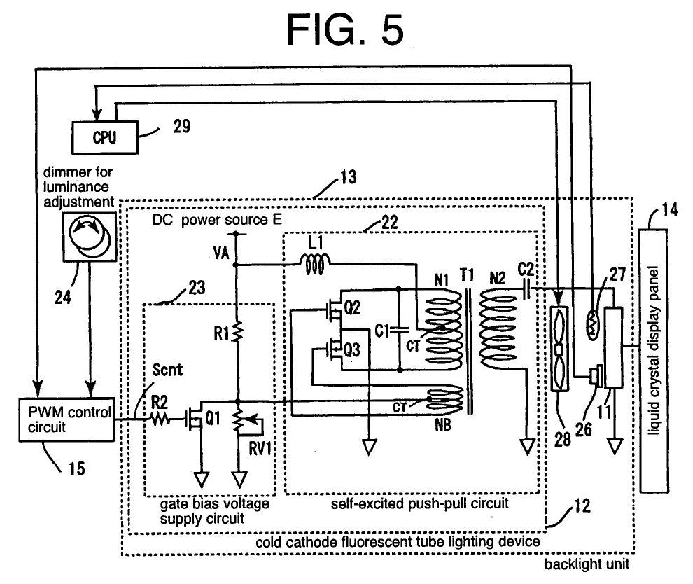

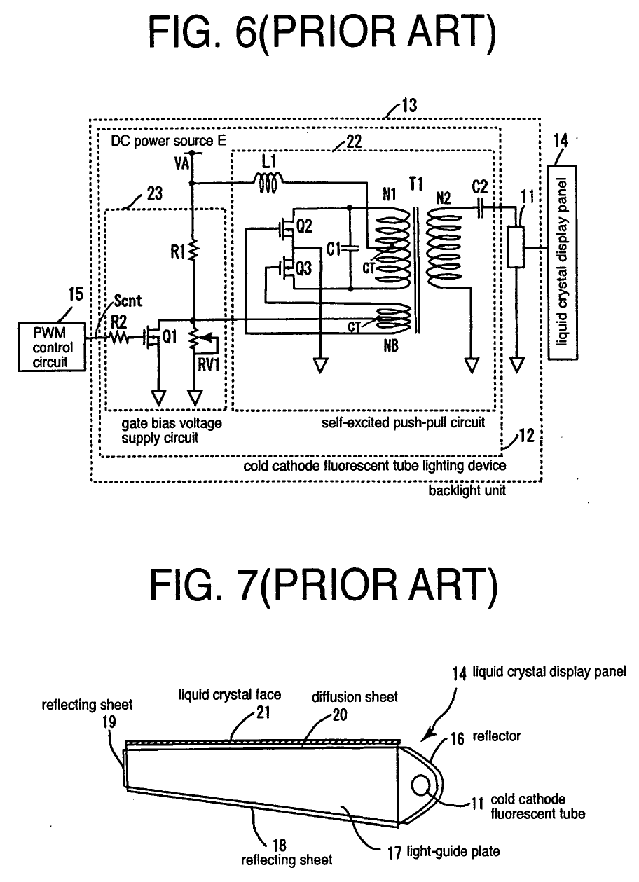

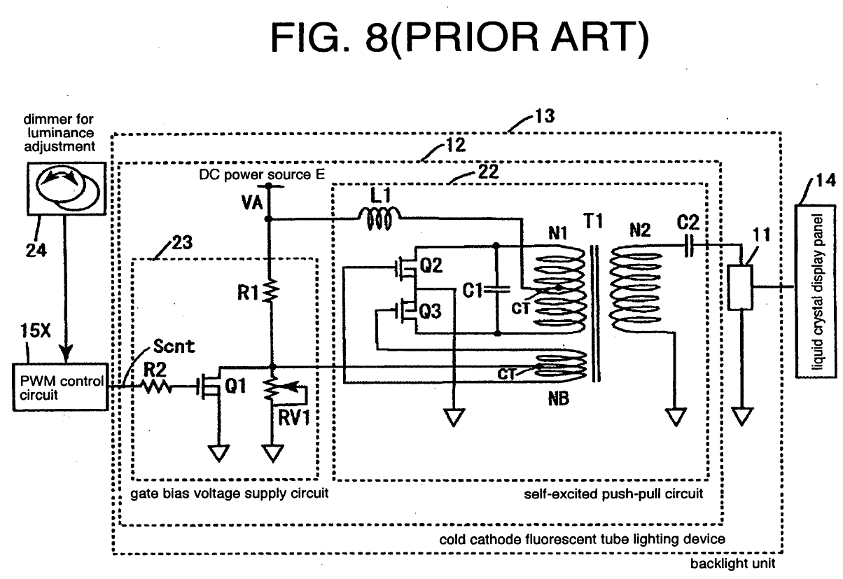

A liquid crystal display device according to the fourth embodiment of the invention is described with reference to FIG. 5.

The liquid crystal display device according to the fourth embodiment includes an internal optical sensor 26 set up in the vicinity of a cold cathode fluorescent tube 11 in the same manner as the liquid crystal display device of the third embodiment described as above, wherein luminance data is fed back to a PWM controller 15 to subject a self-excited push-pull circuit 22 to ON/OFF control, and further includes a thermistor 27, a fan 28 wherein temperature data of the cold cathode fluorescent tube 11 is obtained by the thermistor 27, and the fan 28 is controlled on the basis of the temperature data thus obtained. The control of the fan 28 is effected independently by a controller 29 provided additionally.

As shown in FIG. 5, the liquid crystal display device comprises a backlight unit 13 comprised of a cold cathode fluorescent tube lighting device 12, the cold cathode fluorescent tube 11, the internal optical sensor 26, the thermistor 27, the fan 28, a liquid crystal display panel 14 using the cold cathode fluorescent tube 11 of the backlight unit 13, as light sources thereof, a PWM control circuit 15 for executing operation control of the cold cathode fluorescent tube lighting device 12, and a dimmer 24 for luminance adjustment to control the control pulse signal Scnt sent out from the PWM control device 15, and the controller 29 for controlling the ON/OFF operation of the fan 28 upon receipt of the temperature data from the thermistor 27.

The liquid crystal display panel 14 is the same in configuration as that described with reference to the conventional technology, as shown in FIG. 7, omitting therefore description thereof.

The controller 29 is provided separately from the cold cathode fluorescent tube lighting device 12, and operates independently to control the rotation of the fan 28 on the basis of the temperature data from the thermistor 27 for measuring a tube face temperature of the cold cathode fluorescent tube 11, more specifically, the controller 29 controls the fan 28 to operate it so that the tube face temperature is stable in a range of 60° C. to 70° C. which is most excellent in lighting efficiency.

The PWM control circuit 15 is capable of adjusting luminance of the cold cathode fluorescent tube 11 by means of a dimming method by pulse width modulation, and generates a control pulse signal Scnt for luminance adjustment upon receipt of a signal from the dimmer 24 for luminance adjustment and luminance data from the internal optical sensor 26 to be then delivered to the cold cathode fluorescent tube lighting device 12.

More specifically, an ON/OFF duty control for generating the control pulse signal Scnt is executed by providing a table showing dimmer value from the dimmer 24 for luminance adjustment and a luminance value relative to the dimmer value, which values are compared with value of luminance data fed back from the internal optical sensor 26, thereby controlling the ON-time width.

The dimmer 24 for luminance adjustment controls an ON-time in order to implement luminance adjustment for causing the cold cathode fluorescent tube 11 to be lit up, thereby controlling the ON-time width of the control pulse signal Scnt sent out from the PWM control circuit 15.

The cold cathode fluorescent tube lighting device 12 is connected to the cold cathode fluorescent tube 11, and when it receives the control pulse signal Scnt for ON-duty, at the low level, from the PWM control circuit 15, a DC voltage VA supplied from a DC power source E is divided by resistors R1, RV1, and respective gate voltages of FETs (Q2, Q3) are biased via an intermediate tap CT of a feedback winding NB of a transformer T1, whereupon a self-excited push-pull circuit 22 actuates oscillation to thereby convert the divided voltage into a high AC voltage, and the high AC voltage as converted is supplied to the cold cathode fluorescent tube 11, to thereby light up the cold cathode fluorescent tube controller 11.

More specifically, the cold cathode fluorescent tube lighting device 12 comprises the DC power source E for generating the DC voltage at the voltage VA, a gate bias voltage supply circuit 23, and the self-excited push-pull circuit 22 including the transformer T1, an inductor L1, capacitors C1, C2, and a pair of the n-channel FETs (switching elements) Q2, Q3.

The transformer T1 as a constituent of the self-excited push-pull circuit 22 is provided with a primary winding N1 having the intermediate tap CT, a secondary winding N2, and the feedback winding NB, and the secondary winding N2 has one end grounded, and the other end coupled to one end of the capacitor C2. The capacitor C2 has the other end coupled to the cold cathode fluorescent tube 11. The inductor L1 is an element for causing the DC power source E to function as a constant current source, interconnecting the DC power source E and the intermediate tap CT of the primary winding N1 of the transformer T1. Respective drains of the switching elements Q2, Q3 are connected to respective ends of the primary winding N1, and respective gates thereof are connected to respective ends of the feedback winding NB. With such a circuit configuration as described, an oscillation frequency of the self-excited push-pull circuit 22 is dependent primarily on the capacitor C1 coupled in parallel to the primary winding N1 of the transformer T1, and inductance of the primary winding N1 of the transformer T1.

The gate bias voltage supply circuit 23 has the function of supplying the bias voltage to the respective gates of the switching elements Q2, Q3, and adjusting luminance of the cold cathode fluorescent tube 11 in accordance with the control pulse signal Scnt as inputted, and a switching element Q1 connected to the PWM control circuit 15 via a resistor R2 and an output end of the gate bias voltage supply circuit 23 are connected to a node where the DC voltage undergoes voltage division by the resistor R1, and the variable resistor RV1, further the output end being connected to the intermediate tap CT of the feedback winding NB of the transformer T1.

Now, operation of the cold cathode fluorescent tube lighting device 12 of such a configuration described as above is described hereinafter. In the case of high temperature of the tube face temperature of the cold cathode fluorescent tube 11 which was obtained by the thermistor 27, the controller 29 controls the fan 28 to operate it so that the tube face temperature is controlled so as to be stable in a range of 60° C. to 70, which is most excellent in lighting efficiency, a signal for setting the ON-time width for luminance adjustment is sent out from the dimmer 24 for luminance adjustment and the value of luminance data fed back from the internal optical sensor 26 to the PWM control device 15, and upon receipt of these signals, the PWM control device 15 controls the control pulse signal Scnt matching the signal for setting the ON-time width so as to be at the low level. When the control pulse signal Scnt is controlled at the low level, the switching element Q1 is shifted to the OFF state. Then, a divided voltage is generated through voltage division by the resistor R1, and the variable resistor RV1, and the divided voltage is applied to the respective gates of the switching elements Q2, Q3 as a bias voltage via the intermediate tap CT of the feedback winding NB, thereby turning ON either of the switching elements Q2, Q3. When either the switching element Q2 or the switching element Q3 is turned ON, oscillation is started by the agency of the inductance of the primary winding N1 of the transformer T1 and the capacitor C1. In this connection, an expedient is adopted such that the switching elements Q2, Q3 are turned ON without being shifted abruptly to the ON-state in practice, thereby preventing the self-excited push-pull circuit 22 from causing unnecessary electrical oscillation and mechanical vibration, however, the expedient is omitted in description of the circuit.

In a state where the self-excited push-pull circuit 22 is once actuated, the self-excited push-pull circuit 22 continues self-excited oscillation by the agency of the bias voltage generated due to the ON state of the switching element Q1 to be supplied to the respective gates of the switching elements Q2, Q3 via the feedback winding NB, and a voltage undergoing positive feedback to the respective gates of the switching elements Q2, Q3 via the feedback winding NB. As a result, the high AC voltage is induced in the secondary winding N2. Accordingly, the cold cathode fluorescent tube 11 receives the high AC voltage as induced, and can be lit up.

With the arrangement described above, an ON/OFF duty control of the oscillation operation of the self-excited push-pull circuit 22 is executed by providing the table showing the dimmer value from the dimmer 24 for luminance adjustment and the luminance value relative to the dimmer value, which values are compared with the value of luminance data fed back from the internal optical sensor 26, so that the luminance adjustment can be rapidly implemented to the minimum luminance even at any tube face temperature without causing one-sided lighting.

Further, in the case of high temperature of the tube face temperature of the cold cathode fluorescent tube 11 which was obtained by the thermistor 27, the controller 29 controls the fan 28 to operate it so that the tube face temperature is controlled so as to be stable in a range of 60° C. to 70, which is most excellent in lighting efficiency.

As described above, it is possible to implement luminance adjustment efficiently and rapidly in a wide range even in an environment where an ambient temperature is 71° C. by executing the control using the internal optical sensor 26 and the thermistor 27.

There is provided a liquid crystal display device using cold cathode fluorescent tubes as light sources for a liquid crystal display panel, wherein a plurality of the cold cathode fluorescent tubes, preferably two units of the cold cathode fluorescent tubes are adopted, so that lighting time of one unit of the cold cathode fluorescent tube is first reduced, and lighting time of another unit of the cold cathode fluorescent tube is subsequently reduced to thereby enable a luminance range from the maximum luminance to the minimum luminance to be widened. Further, there is provided a liquid crystal display device wherein luminance adjustment is implemented by keeping luminance characteristics of cold cathode fluorescent tubes in the best state by measuring temperature of the cold cathode fluorescent tubes or controlling the temperature of the cold cathode fluorescent tubes at a constant temperature to thereby enable luminance adjustment in a wide range to be implemented without causing one-sided lighting.

What is claimed is:

1. A liquid crystal display method comprising:
setting up backlights of a liquid crystal display panel by a plurality of cold cathode fluorescent tubes, and
effecting duty control of the plurality of the cold cathode fluorescent tubes individually to thereby implement luminance adjustment between the minimum luminance and the maximum luminance.

2. A liquid crystal display method according to claim 1, wherein in the case of the plurality of the cold cathode fluorescent tubes being two units of the cold cathode fluorescent tubes, the luminance adjustment is implemented such that the maximum luminance is obtained when both the cold cathode fluorescent tubes are controlled for ON-duty while the minimum luminance is obtained when luminance is adjusted by lessening ON-duty for one of the cold cathode fluorescent tubes, and subsequently, turning OFF the one of the cold cathode fluorescent tubes, followed by minimization of ON-duty for the other of the cold cathode fluorescent tubes.

3. A liquid crystal display device comprising:
a liquid crystal display panel;
cold cathode fluorescent tubes for irradiating the liquid crystal display panel with light;
self-excited push-pull circuits for lighting up the cold cathode fluorescent tubes, respectively;
gate bias voltage supply circuits for generating a signal for applying a high AC voltage to the cold cathode fluorescent tubes against the self-excited push-pull circuits, respectively; and
PMW control means for providing the gate bias voltage supply circuits with ON-duty signals, respectively;
wherein the cold cathode fluorescent tubes include a plurality of the cold cathode fluorescent tubes, and the plurality of the cold cathode fluorescent tubes each are provided with the self-excited push-pull circuit, the gate bias voltage supply circuit, and the PMW control means, against the respective PMW control means, a dimming controller being provided for supplying signals to cause the cold cathode fluorescent tubes to discharge, respectively.

4. A liquid crystal display device according to Clam 3, wherein in the case of the plurality of the cold cathode fluorescent tubes being two units of the cold cathode fluorescent tubes, the dimming controller controls such that the maximum luminance is obtained by the ON-duty signals outputted by the respective PMW control means for controlling the two units of cold cathode fluorescent tubes while the minimum luminance is obtained when luminance is adjusted by lessening ON-duty for one of the cold cathode fluorescent tubes, and subsequently, turning OFF the one of the cold cathode fluorescent tubes, followed by control of ON-duty for the other of the cold cathode fluorescent tubes.

5. A liquid crystal display device comprising:
a liquid crystal display panel;
cold cathode fluorescent tubes for irradiating the liquid crystal display panel with light;
self-excited push-pull circuits for lighting up the cold cathode fluorescent tubes, respectively;
gate bias voltage supply circuits for generating a signal for applying a high AC voltage to the cold cathode fluorescent tubes against the self-excited push-pull circuits, respectively; and
PMW control means for providing the gate bias voltage supply circuits with ON-duty signals, respectively;
wherein the PMW control means each control an ON-duty signal on the basis of luminance data from an internal optical sensor set up in the cold cathode fluorescent tube.

6. A liquid crystal display device according to claim 5, further comprising a thermistor for measuring temperature of the cold cathode fluorescent tube, and control means for controlling a fan for cooling the cold cathode fluorescent tube on the basis of temperature data from the thermistor.
